(19) United States
(12) Patent Application Publication
(10) Pub. No.: US 2022/0172042 A1
(43) Pub. Date: Jun. 2, 2022

(54) DYNAMIC CLASSIFICATION ENGINE SELECTION USING RULES AND ENVIRONMENTAL DATA METRICS

(71) Applicant: KYOCERA DOCUMENT SOLUTIONS INC., OSAKA (JP)

(72) Inventors: Oleksandr Zinchenko, Concord, CA (US); Hiroyuki Takaishi, Osaka (JP)

(21) Appl. No.: 17/108,426

(22) Filed: Dec. 1, 2020

(51) Int. Cl. G06N 3/08; G06F 16/93; G06N 3/04; G06F 40/20

(52) U.S. Cl. CPC G06N 3/08; G06F 40/20; G06N 3/04; G06F 16/93

(57) ABSTRACT

A method of document classification engine selection includes receiving metadata from each classification engine of a plurality of classification engines. The metadata indicates operational characteristics for a corresponding classification engine, and the plurality of classification engines run on one or more processors. The method includes determining internal data metrics by polling internal resources corresponding to the one or more processors. The method includes determining external data metrics by polling external resources that are isolated from the one or more processors. The method includes accessing a plurality of rules for application to each document during document classification. The method includes comparing the metadata from each classification engine to the internal data metrics, the external data metrics, and the plurality of rules. The method includes selecting a particular classification engine from the plurality of classification engines based on the comparison and providing the particular classification engine for document classification.

### BACKGROUND

In recent history, enterprises use classification engines to classify documents. As a non-limiting example, a classification engine can classify a first document as belonging to a first document class and can classify a second document as belonging to a second document class. There are a variety of techniques for performing document classification and a variety of classification engines used to perform document classification. As a non-limiting example, a first type of classification engine can use convolutional neural networks (CNNs) to classify documents and a second type of classification engine can use natural language processing (NLP) to classify documents.

There are different advantages to using different types of classification engines. As a non-limiting example, some classification engines can improve accuracy while other classification engines operate with relatively quick classification processing times. Depending on a use-case or desired objective, one type of classification engine may be more desirable than another type of classification engine.

### SUMMARY

In one aspect, a method of document classification engine selection is described. The method includes receiving, at an engine selector, metadata from each classification engine of a plurality of classification engines. The metadata indicates operational characteristics for a corresponding classification engine, and the plurality of classification engines run on one or more processors. The method also includes determining internal data metrics by polling internal resources corresponding to the one or more processors. The method further includes determining external data metrics by polling external resources that are isolated from the one or more processors. The method also includes accessing a plurality of rules for application to each document during document classification. The method further includes comparing the metadata from each classification engine to the internal data metrics, the external data metrics, and the plurality of rules. The method also includes selecting a particular classification engine from the plurality of classification engines based on the comparison and providing the particular classification engine for document classification.

In a further aspect, a system for document classification engine selection is described. The system includes a plurality of classification engines running on one or more processors. Each classification engine of the plurality of classification engines has different operational characteristics. The system also includes an environmental polling unit configured to determine internal data metrics by polling internal resources corresponding to the one or more processors. The environmental polling unit is also configured to determine external data metrics by polling external resources that are isolated from the one or more processors. The system also includes a rules manager having a plurality of rules for application to each document during document classification. The system further includes an engine selector configured to receive metadata from each classification engine of the plurality of classification engines. The metadata indicates operational characteristics for a corresponding classification engine. The engine selector is also configured to compare the metadata from each classification engine to the internal data metrics, the external data metrics, and the plurality of rules. The engine selector is further configured to select a particular classification engine from the plurality of classification engines based on the comparison. The engine selector is also configured to provide the particular classification engine for document classification.

In a further aspect, a non-transitory computer-readable storage medium is described. The non-transitory computer-readable storage medium includes instructions that, when executed by one or more processors, cause the one or more processors to perform functions including receiving metadata from each classification engine of a plurality of classification engines. The metadata indicates operational characteristics for a corresponding classification engine, and the plurality of classification engines run on one or more processors. The functions also include determining internal data metrics by polling internal resources corresponding to the one or more processors. The functions further include determining external data metrics by polling external resources that are isolated from the one or more processors. The functions also include accessing a plurality of rules for application to each document during document classification. The functions further include comparing the metadata from each classification engine to the internal data metrics, the external data metrics, and the plurality of rules. The functions also include selecting a particular classification engine from the plurality of classification engines based on the comparison and providing the particular classification engine for document classification.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 is a diagram of a classification engine selection system, according to an example embodiment.

FIG. 2 illustrates a plurality of rules, according to an example embodiment.

FIG. 3 is another diagram of a classification engine selection system, according to an example embodiment.

FIG. 4 is a simplified block diagram of a computing device, according to an example embodiment.

FIG. 5 is a flowchart of a method, according to an example embodiment.

### DETAILED DESCRIPTION

Example methods and systems are described herein. Other example embodiments or features may further be utilized, and other changes may be made, without departing from the scope of the subject matter presented herein. In the following detailed description, reference is made to the accompanying figures, which form a part thereof.

The ordinal terms first, second, and the like in the description and in the claims are used for distinguishing between similar elements and not necessarily for describing a sequence, either temporally, spatially, in ranking, or in any other manner. As such, it is to be understood that the ordinal terms can be interchangeable under appropriate circumstances.

The example embodiments described herein are not meant to be limiting. Thus, aspects of the present disclosure, as generally described herein and illustrated in the figures, can be arranged, substituted, combined, separated, and designed in a wide variety of different configurations, all of which are explicitly contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. OVERVIEW

Illustrative embodiments relate to example classification engine selection systems and corresponding classification engine selection methods. As described herein, a classification selection system provides flexible techniques for selecting a classification engine based on a set of rules and environmental metrics. For example, a plurality of classification engines can be accessible to an engine selector with each classification engine having unique features. Based on the rules and the environmental metrics (or a subset thereof), the engine selector can select a particular classification engine from the plurality of classification engines to use for document classification.

In some examples, the engine selector uses the rules, such as business rules, to track user and business needs and environmental polling to track changes to external and internal environmental configurations. Based on the rules and environmental polling, the engine selector can select the particular classification engine that can accommodate the needs of the user and business. For example, the rules can indicate how certain documents are to be classified according to a set of standards associated with a particular business. The engine selector can identify classification engines from the plurality of classification engines that are able to support (e.g., are able to classify documents according to) the rules. For example, the engine selector can identify the classification engines that are able to support the rules based on the unique features of each classification engine. The environmental polling can be used by the engine selector to select a classification engine, from the identified classification engines, that is determined to operate at a high level under the environmental conditions. Non-limiting examples of the environmental conditions can include an available central processing unit (CPU) availability, random access memory (RAM) availability, temperature, etc.

As shown, the engine selector can be configured to quickly search for a classification engine that can meet needs of the user, business, or both. Other benefits will be apparent to those skilled in the art.

### II. EXAMPLE SYSTEMS AND METHODS

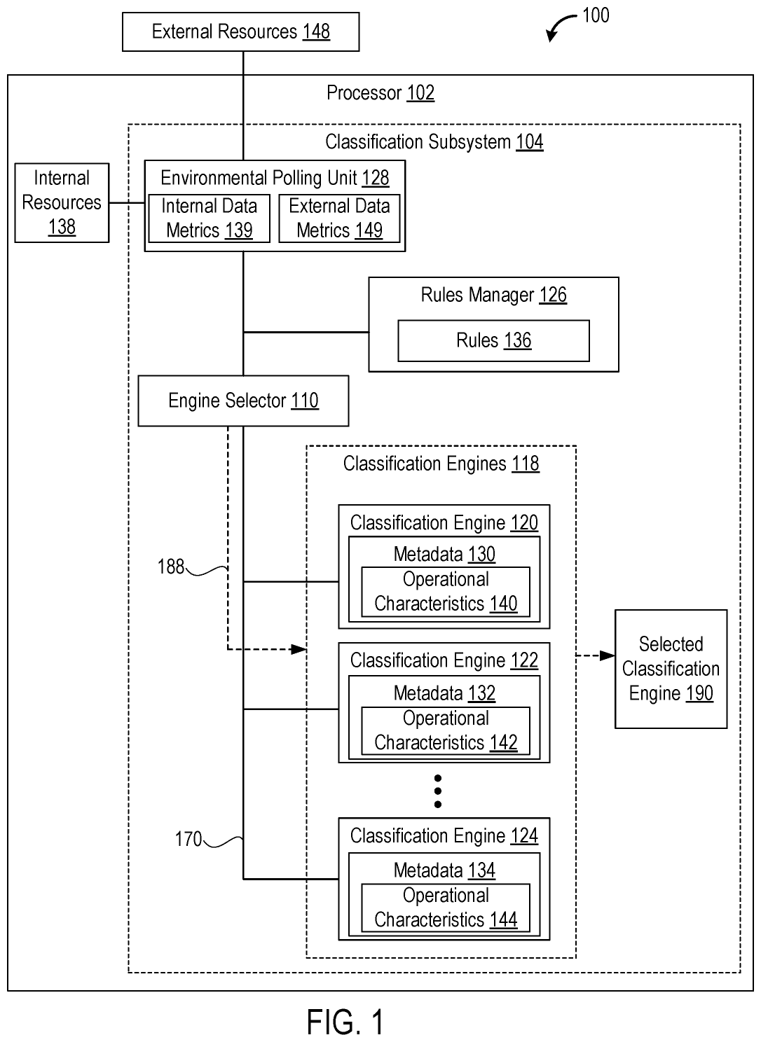

FIG. 1 depicts a diagram of a classification engine selection system 100, according to an example embodiment. As shown, the system 100 includes one or more processors, illustrated as a processor 102. Although a single processor 102 is illustrated, in other implementations, the processor 102 can correspond to multiple processors or a multi-core processor. The processor 102 can be a central processing unit (CPU), a graphics processing unit (GPU), a digital signal processor (DSP), etc.

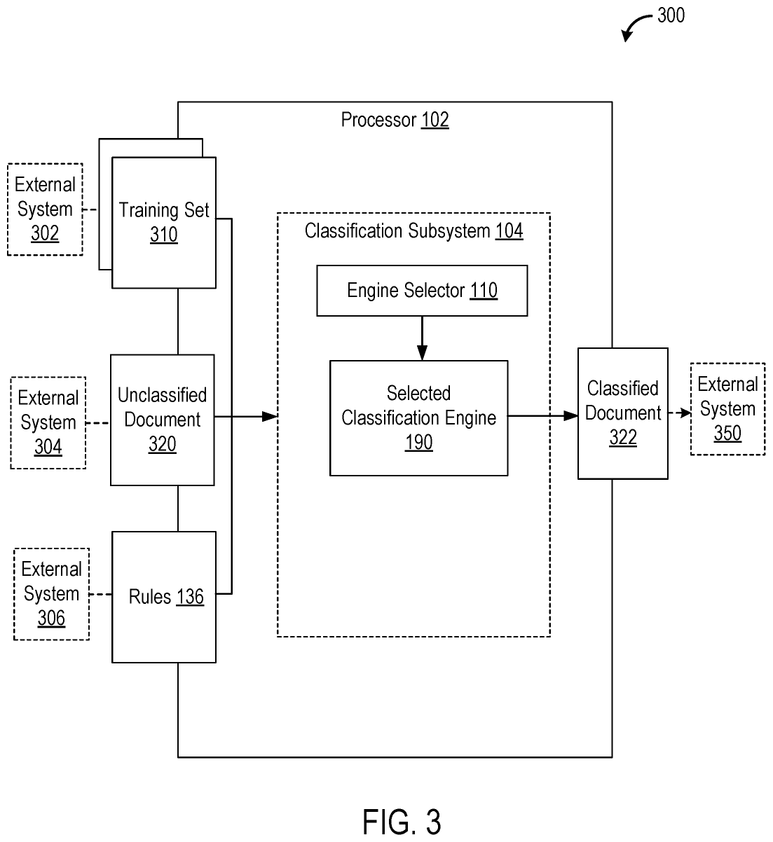

The processor 102 includes a classification subsystem 104. The classification subsystem 104 may be integrated into the processor 102 to classify one or more documents, such as the unclassified document 320 illustrated in FIG. 3. Components of the classification subsystem 104 are configured to run on the processor 102. The classification subsystem 104 includes an engine selector 110, a plurality of classification engines 118, a rules manager 126, and an environmental polling unit 128. The components of the processor 102 can be implemented using dedicated circuitry (e.g., a field programmable gate arrays (FPGA), an application-specific integrated circuit (ASIC), etc.) or by instructions executed by the processor 102. As described herein, the engine selector 110 is configured to select a classification engine to use for document classification based on a variety of factors.

The plurality of classification engines 118 includes a classification engine 120, a classification engine 122, and a classification engine 124. Although three classification engines 120, 122, 124 are illustrated in FIG. 1, it should be understood that the techniques described herein can be achieved using N classification engines, where N is any integer value that is larger than one (1). As a non-limiting example, if N is equal to two (2), the plurality of classification engines 118 can include two (2) classification engines. As another non-limiting example, if N is equal to eight (8), the plurality of classification engines 118 can include eight (8) classification engines. Thus, the three classification engines 120, 122, 124 are merely for illustrative purposes and should not be construed as limiting.

The classification engine 120 includes metadata 130, which can be sent to the engine selector 110. As a non-limiting example, the classification engine 120 can be coupled to the engine selector 110 via a bus 170, and the metadata 130 is sent to the engine selector 110 via the bus 170. The metadata 130 indicates operational characteristics 140 for the classification engine 120. The operational characteristics 140 indicate features for the classification engine 120 that are used by the engine selector 110 in selecting a classification engine from the plurality of classification engines 118. As non-limiting examples, the operational characteristics 140 can indicate (i) whether the classification engine 120 supports a graphic processing unit (GPU), (ii) whether the classification engine 120 supports a central processing unit (CPU), (iii) whether the classification engine 120 uses optical character recognition (OCR) and natural language processing (NLP), (iv) whether the classification engine 120 processes text data and graphical data, (v) languages supported by the classification engine 120, (vi) whether the classification engine 120 uses a convolutional neural network (CNN), (vii) whether the classification engine 120 supports CPU extensions, such as AVX-2 or AVX-512, (viii) whether the classification engine 120 supports document level classifications, (ix) whether the classification engine 120 supports a hierarchical or nested classification, (x) whether the classification engine 120 can return multiple classification suggestions and corresponding confidence values, (xi) whether the classification engine 120 supports data redaction for removal of sensitive information, (xii) whether the classification engine 120 supports data indexing and data extraction, (xiii) other features, or (xiv) a combination thereof. As described below, the operational characteristics 140 are usable by the engine selector 110 to determine which classification engine of the plurality of classification engines 118 is selected for a particular use case.

In a similar manner, the classification engines 122, 124 include metadata 132, 134, respectively, that is sent to the engine selector 110. As a non-limiting example, the classification engines 122, 124 can be coupled to the engine selector 110 via the bus 170, and the metadata 132, 134 is sent to the engine selector 110 via the bus 170. The metadata 132 indicates operational characteristics 142 for the classification engine 122. The operational characteristics 142 indicate features for the classification engine 122 that are used by the engine selector 110 in selecting a classification engine. According to one implementation, the operational characteristics 142 are substantially similar to the operational characteristics 140 described above with respect to the classification engine 120. The metadata 134 indicates operational characteristics 144 for the classification engine 124. The operational characteristics 144 indicate features for the classification engine 124 that are used by the engine selector 110 in selecting a classification engine. According to one implementation, the operational characteristics 144 are substantially similar to the operational characteristics 140 described above with respect to the classification engine 120.

According to one implementation, the classification subsystem 104 is extendable to dynamically register additional classification engines. For example, an additional classification engine (not shown) can be dynamically added or “registered” with the classification subsystem 104 and included in the plurality of classification engines 118. In this scenario, metadata indicating operational characteristics of the additional classification engine is provided to the engine selector 110. According to one implementation, the classification subsystem 104 includes a database (not shown) to store the operational characteristics 140, 142, 144 and supported features of each classification engine 120, 122, 124 in the plurality of classification engines 118 to enable the engine selector 110 to compare the features of each classification engine 120, 122, 124 in the plurality of classification engines 118.

The environmental polling unit 128 is coupled to the engine selector 110 and is configured to determine internal data metrics 139 by polling internal resources 138 corresponding to the processor 102. The internal resources 138 include resources that are internal to the classification subsystem 104 (e.g., an “internal environment”) or internal to the processor 102. For example, the internal environment is an environment that is directly accessible from a current computational node (e.g., the processor 102) or is physically part of the computational node, such that it cannot be logically separated. Non-limiting examples of the internal data metrics 139 can include a load of the processor 102, an amount of available random access memory (RAM) that is accessible to the processor 102, an amount of power consumption by the processor 102, an availability of a GPU unit, an amount of simultaneously running classifications, an amount of available hard disk drive (HDD) and solid-state drive (SSD), installed libraries, available CPU features, etc.

The environmental polling unit 128 is also configured to determine external data metrics 149 by polling external resources 148 that are isolated from the processor 102. The external resources 148 include resources that are external to the classification subsystem 104 (e.g., an “external environment”) or external to the processor 102. For example, the external environment is an environment that is not related to the classification subsystem 104 and not related to the node (e.g., the processor 102) that the classification subsystem 104 is running on. Non-limiting examples of the external data metrics 149 can include an outside temperature, a time of day, a day of a week, a humidity level, an illuminance level, a sound level (e.g., a decibel level), a cluster power consumption, etc.

The environmental polling unit 128 is configured to send the internal and external data metrics 139, 149 to the engine selector 110 to notify the engine selector 110 about changes to the environment. According to one implementation, the environmental polling unit 128 periodically polls the internal and external resources 138, 148 (e.g., the internal and external environments) to determine the internal and external data metrics 139, 149. For example, the environmental polling unit 128 periodically connects to different sensors and retrieves information about the current state of the sensors. As a non-limiting example, the environmental polling unit 128 can periodically query an operating system for the current CPU load, the amount of available RAM, or the existence of a GPU. According to another implementation, the environmental polling unit 128 can receive event-based notifications from sensors. In this implementation, sensors associated with the internal and external resources 138, 148 can send real-time changes of a sensed state to the environmental polling unit 128. For example, a thermostat or a Watt meter can send real-time notifications to the environmental polling unit 128 about the current temperature or power consumption, respectively.

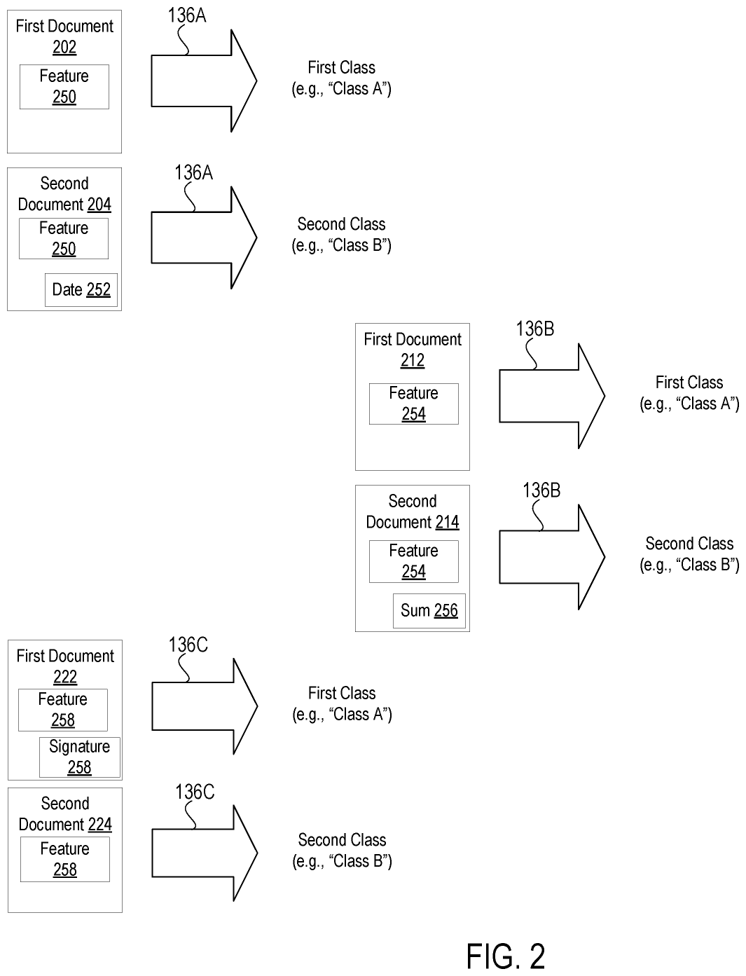

The rules manager 126 is coupled to the engine selector 110. The rules manager 126 has a plurality of rules 136 for application to each document during document classification. The rules manager 126 stores and manages the rules 136. According to one implementation, the rules manager can correspond to a “business rules manager” that stores and manages business rules. As used herein, a “rule” or a “business rule” is a condition that describes use-cases and specific scenarios that are applied to documents during document classification. Each rule 136 can describe a specific business use case. For example, each rule 136 can indicate a condition or scenario that a particular business uses to classify documents. Examples of rules or “business rules” are described with respect to FIG. 2.

Referring to FIG. 2, illustrative examples of rules 136 are depicted. It should be understood that the examples depicted in FIG. 2 are for illustrative purposes and are not intended to be limiting.

According to a first example, a particular rule 136A can (i) assign a first document 202 having a feature 250 to a first class (e.g., “Class A”) and (ii) assign a second document 204, having the feature 250 and having an extracted date 252 that is older than a particular time period, to a second class (e.g., “Class B”). For example, if the document 204 is classified in the first class but the extracted date 252 from the document 204 is older than sixty (60) days, the particular rule 136A can instruct a classification engine to assign the document 204 to the second class.

According to a second example, a particular rule 136B can (i) assign a first document 212 having a feature 254 to a first class (e.g., “Class A”) and (ii) assign a second document 214, having the feature 254 failing a total sum 256 that exceeds a threshold value, to a second class (e.g., “Class B”). For example, if the document 214 is classified in the first class but the total sum is larger than $10,000, the particular rule 136B can instruct a classification engine to assign the document 214 to the second class.

According to a third example, a particular rule 136C can (i) assign a first document 222 having a feature 258 and a signature 260 to a first class (e.g., “Class A”) and (ii) assign a second document 224, having the feature 258 and failing to have a signature, to a second class (e.g., “Class B”). For example, if the document 224 fails to have a signature on a particular page, the particular rule 136C can instruct a classification engine to assign the document 224 to the second class.

Thus, the rules 136A-C and the rules manager 126 may represent specifics of different business use-cases. As described below, the rules 136A-C and the rules manager 126 may affect which classification engine 120, 122, 124 is selected by the engine selector 110. For example, one or more of the classification engines 120, 122, 124 may not be able to support particular rules 136 or may have limited support for some documents.

Referring back to FIG. 1, the engine selector 110 is configured to receive the metadata 130, 132, 134 from each classification engine 120, 122, 124, respectively, and to compare the metadata 130, 132, 134 from each classification engine 120, 122, 124 to the internal data metrics 139, the external data metrics 149, and the plurality of rules 136. Based on the comparison, the engine selector 110 is configured to select a particular classification engine 122, 122, 124 of the plurality of classification engines 118 for document classification. For example, the engine selector 110 can issue a selection signal 188 to the plurality of classification engines 118 that indicates which classification engine 120, 122, 124 is a selected classification engine 190.

During the comparison, the engine selector 110 is configured to identify a subset of classification engines, from the plurality of classification engines 118, which can support the plurality of rules 136. For example, based on the operational characteristics 140, 142, 144 of each classification engine 120, 122, 124, the engine selector 110 can identify the subset of classification engines that support the rules 136. If the engine selector 110 determines that subset includes only one classification engine, the engine selector 110 is configured to select that classification engine as the selected classification engine 190. To illustrate, if the classification engine 120 is the only classification engine in the plurality of classification engines 118 that supports the rules 136, the engine selector 110 selects the classification engine 120 as the selected classification engine 190.

However, according to one implementation, in response to a determination that there is more than one classification engine in the subset, the engine selector 110 is configured to rank each classification engine in the subset based on an ability to support the internal data metrics 139 and an ability to support the external data metrics 149. To illustrate, if the classification engines 120, 122 can support the rules 136, the engine selector 110 can rank the classification engines 120, 122 based on their abilities to support the data metrics 139, 149. In response to a determination that the classification engine 122 supports more of the data metrics 139, 149 than the classification engine 120, the engine selector 110 is configured to select the classification engine 122 as the selected classification engine 190.

According to another implementation, in response to a determination that there is more than one classification engine in the subset, the engine selector 110 is configured to identify a classification engine in the subset that is configured to support (i) at least a threshold number of the internal data metrics 139 and (ii) at least a threshold number of the external data metrics 149. To illustrate, if the classification engines 120, 122 can support the rules 136, the engine selector 110 can determine which classification engine 120, 122 satisfies a threshold number of data metrics 139, 149. As a non-limiting example, if the threshold number of internal data metrics 139 is five (5) and the threshold number of external data metrics 149 is three (3), the engine selector 110 can determine whether at least one of the classification engines 120, 122 satisfy five internal data metrics 139 and three external data metrics 149. If only the classification engine 122 satisfies five internal data metrics 139 and three external data metrics 149, the engine selector 110 is configured to select the classification engine 122 as the selected classification engine 190. However, if both classification engines 120, 122 satisfy five internal data metrics 139 and three external data metrics 149, the engine selector 110 is configured to prioritize specific data metrics to determine which classification engine 120, 122 to select. As a non-limiting example, if an ability to support GPU is a high priority metric, the engine selector 110 can select the classification engine 120, 122 that supports GPU.

Described below are specific examples of the engine selector 110 using the internal and external data metrics 139, 149 to rank classification engines that support the rules 136. For example, the engine selector 110 may use the operational characteristics 140, 142, 144 of the classification engines 120, 122, 124 that support the rules 136 to determine which classification engine 120, 122, 124 can operate at a high level based on the internal and external data metrics 139, 149. It should be understood that the examples described below are merely for illustrative purposes and should not be construed as limiting.

According to one example, the engine selector 110 can select the particular classification engine 190 based on internal data metrics 139, such as an availability of computational resources. To illustrate, if the operational characteristics 140 indicate that the classification engine 120 supports running classifications on a GPU, as opposed to a CPU, and the internal data metrics 139 indicate that the GPU is available, the engine selector 110 may select the classification engine 120 as the selected classification engine 190 over a classification engine that runs on a CPU. According to another example, if the operational characteristics 142 indicate that the classification engine 122 supports running classifications on a CPU that supports advanced vector extensions (AVX) and the internal data metrics 139 indicate that a CPU supporting AVX is available, the engine selector 110 may select the classification engine 122 as the selected classification engine 190.

Internal data metrics 139, such as an available RAM, can also be used by the engine selector 110 to select the classification engine 190. To illustrate, the metadata 130, 132, 134 from each classification engine 120, 122, 124 can indicate the respective RAM requirements of the classification engines 120, 122, and 124. If a node or the processor 102 is overloaded with tasks and the amount of available RAM is insufficient for the classification engine 120 according to the RAM requirements, but sufficient for the classification engine 122, the engine selector 110 can select the classification engine 122 as the selected classification engine 190.

Internal data metrics 139, such as an available HDD, can also be used by the engine selector 110 to select the classification engine 190. To illustrate, the metadata 130, 132, 134 from each classification engine 120, 122, 124 can indicate the respective HDD requirements. If the node or the processor 102 is overloaded with task and the amount of available HDD is insufficient for the classification engine 122 according to the HDD requirements, but sufficient for the classification engine 124, the engine selector 110 can select the classification engine 124 as the selected classification engine 190.

Internal data metrics 139, such as CPU load, can also be used by the engine selector 110 to select the classification engine 190. To illustrate, the metadata 130, 132, 134 from each classification engine 120, 122, 124 can indicate the CPU requirements. If the node or processor 102 is overloaded, the engine selector 110 can select the classification engine 120, 122 124 that is the least CPU intensive as the selected classification engine 190.

External data metrics 149, such as a luminance level, can also be used by the engine selector 110 to select the classification engine 190. For example, solar panels may be used to generate electricity based on the luminance level. If the luminance level decreases, the engine selector 110 may be configured to select a classification engine 120, 122, 124 that consumes a relatively low amount of power.

According to some implementations, the engine selector 110 can select the classification engine 190 based on business-specific requirements. As a non-limiting example, if classification accuracy has a relatively high priority and the classification engine 124 is more accurate than the other classification engines 120, 122, the engine selector 110 can select the classification engine 124 as the selected classification engine 190. As another non-limiting example, if throughput, volume, and processing speed are of higher priority than accuracy, the engine selector 110 can select a classification engine 120, 122, 124 that has a relatively high processing speed. To illustrate, if the processing speed of the classification engine 122 is higher than the processing speeds of the other classification engines 120, 124, the engine selector 110 can select the classification engine 122 as the selected classification engine 190.

According to some scenarios, it may be desirable to reduce expenses during night hours or weekends. For example, during night hours, weekends, and holidays, there may not be a high demand to quickly process documents. If the classification engine 120 is associated with a third-party provider and the classification engine 122 is cheaper but less powerful than the classification engine 120, the engine selector 110 can select the classification engine 122 as the selected classification engine 190 during night hours, weekends, and holidays. According to another scenario, the engine selector 110 can select the classification engine 120, 122, 124 with the least amount of crashes and operational errors.

According to some implementations, the engine selector 110 can select the classification engine 190 based on customer-specific requirements. As a non-limiting example, if the classification engine 124 generates less noise than the other classification engines 120, 122, the engine selector 110 can select the classification engine 124 as the classification engine 190 during work hours. As a result, workers would not readily be disrupted or distracted by noise. As another non-limiting example, if the classification engine 122 generates less heat than the other classification engines 120, 124, the engine selector 110 can select the classification engine 122 during work hours to reduce heat in a work environment.

According to another implementation of selecting the classification engine 190 based on customer-specific requirements, the engine selector 110 can select the classification engine 120, 122, 124 that returns multiple document classes and confidence levels for each document class. For example, if the classification engine 120 returns a table of possible document classes and a confidence level for each document class, and the classification engines 122, 124 return single document classes, the engine selector 110 can select the classification engine 120 as the selected classification engine 190.

According to some implementations, the engine selector 110 can select the classification engine 190 based on document-specific requirements. As a non-limiting example of document-specific requirements, the engine selector 110 can select a classification engine that supports data extraction and data indexing. According to this example, in addition to document classification, the selected classification engine 190 can be configured to extract portions of data from a document alongside with a document class. As another non-limiting example of document-specific requirements, the engine selector 110 can select a classification engine that supports data redaction. According to this example, in addition to document classification, the selected classification engine 190 can perform data redaction prior to sharing of the classified document.

As another non-limiting example of document-specific requirements, the engine selector 110 can select a classification engine based on a shape of a document. For example, the classification subsystem 104 can pre-classify a document to determine the shape of the document. To illustrate, before selecting a classification engine, the classification subsystem 104 can run a pre-classification operation to determine whether the shape of the document is plain text, text with tables, graphical, image, etc. In response to determining the shape of the document, the engine selector 110 can select the classification engine based on the shape. For example, the engine selector 110 can select an NLP classification engine for a document with plain text shape, the engine selector 110 can select a CNN classification engine for a document with an image shape, etc.

As another non-limiting example of document-specific requirements, the engine selector 110 can select a classification engine based on a language associated with a document. For example, the classification subsystem 104 can run a text extraction operation on the document to identify the language associated with the document. In response to determining the language, the engine selector 110 can select the classification engine based on the language. For example, the engine selector 110 can select an NLP classification engine that supports the specific language.

As another non-limiting example of document-specific requirements, the engine selector 110 can select a classification engine that supports the classification of multi-page documents. As yet another non-limiting example of document-specific requirements, the engine selector 110 can select a classification engine that supports the classification of hierarchical documents.

Thus, the system 100 described with respect to FIG. 1 enables selection of different classification engines 120, 122, and 124 based on environmental characteristics, represented by the internal and external data metrics 139, 149, and the rules 136. Based on the metadata 130, 132, 134, it should be appreciated that the classification subsystem 104 can quickly search for a classification engine that supports a specific feature, compare classification engines with each other to find differences in supported features, find a subset of classification engines that support a desired feature, and/or rank classification engines based on supported features. Additionally, the classification subsystem 104 can measure side effects that are caused by each classification engine 120, 122, and 124, such as CPU consumption, RAM consumption, power consumption, noise generation, temperature fluctuations, etc. As a result, the selected classification engine 190 has operational characteristics that support the requirements for pending document classifications.

FIG. 3 depicts another diagram of a classification engine selection system 300, according to an example embodiment. As shown, the system 300 includes the processor 102, an external system 302, an external system 304, an external system 306, and an external system 350. The external systems 302, 304, 306, 350 can include any other systems that can be integrated with the classification subsystem 104 using an application programming interface (API). The external system 302 is configured to provide a training set 310 to the classification subsystem 104, the external system 304 is configured to provide an unclassified document 320 to the classification subsystem 104, and the external system 306 is configured to provide the rules 136 to the classification subsystem 104.

The training set 310 is a set of document examples that are used to train one or more of the classification engines 120, 122, 124, including the selected classification engine 190. Prior to classifying the unclassified document 320, the selected classification engine 190 is trained based on the training set 310.

According to one implementation, the training set 310 can be applied to all of the classification engines 120, 122, 124. According to this implementation, the training set 310 is a “shared training set.” Using a shared training set may result in simplified training across different classification engines 120, 122, 124 and low maintenance efforts.

According to another implementation, the training set 310 can be applied to a subset of the classification engines 120, 122, 124. According to this implementation, the training set 310 is an “engine-specific training set.” For example, the training set 310 could be used for a first classification engine based on natural language processing (NLP) or could be used for a second classification engine based on a convolutional neural network (CNN). Using an engine-specific training set results in more control, flexibility, and support for different types of classification engines than a shared training set.

The selected classification engine 190 is configured to perform a classification operation on the unclassified document 320 to generate a classified document 322. The classification subsystem 104 provides the classified document 322 to the external system 350.

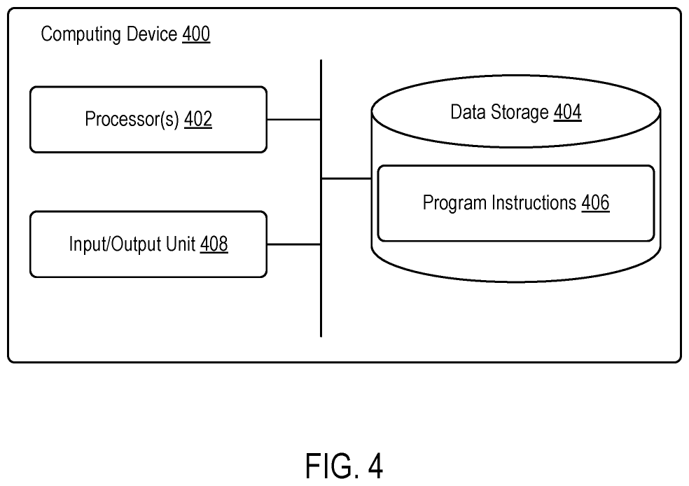

FIG. 4 illustrates a simplified block diagram of a computing device 400, which can be configured to carry out the methods, processes, or functions disclosed in this specification and/or the accompanying drawings. Any of the components described above, such as the processor 102, the classification subsystem 104, and/or the classification engines 118, can be implemented as, or can be integrated within, the computing device 400. Generally, the manner in which the computing device 400 is implemented can vary, depending upon the particular application.

The computing device 400 can include one or more processors 402, data storage 404, program instructions 406, and an input/output unit 408, all of which can be coupled by a system bus or a similar mechanism. The one or more processors 402 can include one or more central processing units (CPUs), such as one or more general purpose processors and/or one or more dedicated processors (e.g., application specific integrated circuits (ASICs) or digital signal processors (DSPs), etc.). The one or more processors 402 can be configured to execute computer-readable program instructions 406 that are stored in the data storage 404 and are executable to provide at least part of the functionality described herein. According to one implementation, the one or more processors 402 can include the processor 102.

The data storage 404 can include or take the form of one or more non-transitory, computer-readable storage media that can be read or accessed by at least one of the one or more processors 402. The non-transitory, computer-readable storage media can include volatile and/or non-volatile storage components, such as optical, magnetic, organic, or other memory or disc storage, which can be integrated in whole or in part with at least one of the one or more processors 402. In some embodiments, the data storage 404 can be implemented using a single physical device (e.g., one optical, magnetic, organic, or other memory or disc storage unit), while in other embodiments, the data storage 404 can be implemented using two or more physical devices.

The input/output unit 408 can include network input/output devices. Network input/output devices can include wired network receivers and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, and/or wireless network receivers and/or transceivers, such as a Bluetooth transceiver, a ZigBee transceiver, a Wi-Fi transceiver, a WiMAX transceiver, a wireless wide-area network (WWAN) transceiver and/or other similar types of wireless transceivers configurable to communicate via a wireless network.

The input/output unit 408 can additionally or alternatively include user input/output devices and/or other types of input/output devices. For example, the input/output unit 408 can include a touch screen, a keyboard, a keypad, a computer mouse, liquid crystal displays (LCD), light emitting diodes (LEDs), displays using digital light processing (DLP) technology, cathode ray tubes (CRT), light bulbs, and/or other similar devices.

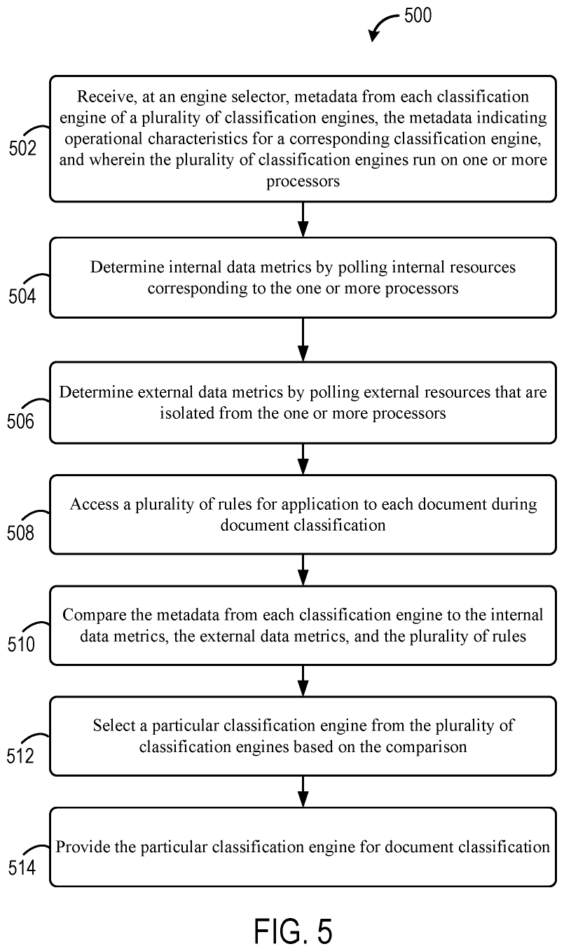

FIG. 5 depicts a flowchart of an example method 500 that can be carried out in connection with one or more of the systems described herein. The example method 500 can include one or more operations, functions, or actions, as depicted by one or more of blocks 502-514, each of which can be carried out by the systems described by way of FIGS. 1-4; however, other configurations could be used as well.

Furthermore, those skilled in the art will understand that the flowchart described herein illustrates functionality and operation of certain implementations of example embodiments. In this regard, each block of the flowchart can represent a module or a portion of program code, which includes one or more instructions executable by a processor for implementing, managing, or driving specific logical functions or steps in the method 500. The program code can be stored on any type of computer readable medium, for example, such as a storage device including a disk or hard drive. In addition, each block can represent circuitry that is wired to perform the specific logical functions in the method 500. Alternative implementations are included within the scope of the example embodiments of the present application in which functions can be executed out of order from that shown or discussed, including substantially concurrent order, depending on the functionality involved, as would be understood by those reasonably skilled in the art.

Referring to FIG. 5, the method 500 includes receiving, at an engine selector, metadata from each classification engine of a plurality of classification engines, at 502. The metadata indicates operational characteristics for a corresponding classification engine, and the plurality of classification engines run on one or more processors. For example, referring to FIG. 5, the engine selector 110 receives the metadata 130, 132, 134 from each classification engine 120, 122, and 124 of the plurality of classification engines 118. The metadata 130, 132, 134 indicates the operational characteristics 140, 142, 144 for the corresponding classification engines 120, 122, 124, and the plurality of classification engines 118 run on the processor 102.

The method 500 also includes determining internal data metrics by polling internal resources corresponding to the one or more processors, at 504. For example, referring to FIG. 1, the engine selector 110 determines the internal data metrics 139 by polling the internal resources 138 corresponding to the processor 102.

The method 500 also includes determining external data metrics by polling external resources that are isolated from the one or more processors, at 506. For example, referring to FIG. 1, the engine selector 110 determines the external data metrics 149 by polling the external resources 148 that are isolated from the processor 102.

The method 500 also includes accessing a plurality of rules for application to each document during document classification, at 508. For example, referring to FIG. 1, the engine selector 110 accesses the rules 136 from the rules manager 126. The rules 136 are applied to documents during document classification by the selected classification engine 190.

The method 500 also includes comparing the metadata from each classification engine to the internal data metrics, the external data metrics, and the plurality of rules, at 510. For example, referring to FIG. 1, the engine selector 110 compares the metadata 130, 132, 134 from each classification engine 120, 122, and 124 to the internal data metrics 139, the external data metrics 149, and the rules 136.

The method 500 also includes selecting a particular classification engine from the plurality of classification engines based on the comparison, at 512. For example, referring to FIG. 1, the engine selector 110 selects one of the classification engines 120, 122, 124 from the plurality of classification engines 118 as the selected classification engine 190 based on the comparison.

According to one implementation, during the comparison and prior to selection of the particular classification engine, the method 500 can include identifying, from the plurality of classification engines, a subset of classification engines configured to support the plurality of rules. The subset of classification engines can include the particular classification engine. The method 500 can also include determining whether the subset of classification engines includes more than one classification engine. Responsive to determining that the subset of classification engines include only one classification engine, the method 500 can include selecting the one classification engine as the particular classification engine.

However, in response to a determination that there is more than one classification engine in the subset of classification engines, the method 500 can include ranking each classification engine in the subset of classification engines based on an ability to support the internal data metrics and an ability to support the external data metrics. The method 500 can also include identifying a given classification engine having a top rank such that the particular classification engine corresponds to the given classification engine. According to another implementation, in response to a determination that there is more than one classification engine in the subset of classification engines, the method 500 can include identifying a classification engine in the subset of classification engines configured to support (i) at least a threshold number of the internal data metrics and (ii) at least a threshold number of the external data metrics. In this implementation, the particular classification engine corresponds to the identified classification engine.

The method 500 also includes providing the particular classification engine for document classification, at 514. For example, referring to FIG. 1, the engine selector 110 can provide the selected classification engine 190 for document classification.

Thus, the method 500 can enable selection of different classification engines 120, 122, 124 based on environmental characteristics, represented by the internal and external data metrics 139, 149, and the rules 136. As a result, the selected classification engine 190 has operational characteristics that can support the requirements for pending document classifications.

### III. CONCLUSION

The particular arrangements shown in the Figures should not be viewed as limiting. It should be understood that other embodiments can include more or less of each element shown in a given Figure. Further, some of the illustrated elements can be combined or omitted. Yet further, example embodiments can include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

1. A system for document classification engine selection, the system comprising:
a plurality of classification engines running on one or more processors, each classification engine of the plurality of classification engines having different operational characteristics;
an environmental polling unit configured to:
determine internal data metrics by polling internal resources corresponding to the one or more processors; and
determine external data metrics by polling external resources that are isolated from the one or more processors;
a rules manager having a plurality of rules for application to each document during document classification; and
an engine selector configured to:
receive metadata from each classification engine of the plurality of classification engines, the metadata indicating operational characteristics for a corresponding classification engine;
compare the metadata from each classification engine to the internal data metrics, the external data metrics, and the plurality of rules;
select a particular classification engine from the plurality of classification engines based on the comparison; and
provide the particular classification engine for document classification.

2. The system of claim 1, wherein, during the comparison and prior to selection of the particular classification engine, the engine selector is configured to:
identify, from the plurality of classification engines, a subset of classification engines configured to support the plurality of rules, wherein the subset of classification engines includes the particular classification engine; and
determine whether the subset of classification engines includes more than one classification engine.

3. The system of claim 2, wherein the engine selector is further configured to:
responsive to determining that the subset of classification engines includes only one classification engine, select the one classification engine as the particular classification engine.

4. The system of claim 2, wherein, in response to a determination that there is more than one classification engine in the subset of classification engines, during the comparison and prior to selection of the particular classification engine, the engine selector is configured to:
rank each classification engine in the subset of classification engines based on an ability to support the internal data metrics and an ability to support the external data metrics; and
identify a given classification engine having a top rank such that the particular classification engine corresponds to the given classification engine.

5. The system of claim 2, wherein, in response to a determination that there is more than one classification engine in the subset of classification engines, during the comparison and prior to selection of the particular classification engine, the engine selector is configured to:
identify a classification engine in the subset of classification engines configured to support: (i) at least a threshold number of the internal data metrics and (ii) at least a threshold number of the external data metrics, wherein the particular classification engine corresponds to the identified classification engine.

6. The system of claim 1, wherein the internal data metrics include at least one of a load of the one or more processors, an amount of available random access memory (RAM), or an amount of power consumption by the one or more processors.

7. The system of claim 1, wherein the external data metrics include at least one of an outside temperature, a time of day, a day of a week, a humidity level, an illuminance level, or a sound level.

8. The system of claim 1, wherein the plurality of rules assign first documents having a first feature to a first class, and wherein the plurality of rules assign second documents, having the first feature and having an extracted date that is older than a particular time period, to a second class.

9. The system of claim 1, wherein the plurality of rules assign first documents having a first feature to a first class, and wherein the plurality of rules assign second documents, having the first feature and having a total sum that exceeds a threshold value, to a second class.

10. The system of claim 1, wherein the plurality of rules assign first documents having a first feature to a first class, and wherein the plurality of rules assign second documents, having the first feature and failing to have a signature on a particular page, to a second class.

11. The system of claim 1, wherein the plurality of classification engines comprise a first classification engine based on natural language processing (NLP) and a second classification engine based on a convolutional neural network (CNN).

12. A method of document classification engine selection, the method comprising:
receiving, at an engine selector, metadata from each classification engine of a plurality of classification engines, the metadata indicating operational characteristics for a corresponding classification engine, and wherein the plurality of classification engines run on one or more processors;
determining internal data metrics by polling internal resources corresponding to the one or more processors;
determining external data metrics by polling external resources that are isolated from the one or more processors;
accessing a plurality of rules for application to each document during document classification;
comparing the metadata from each classification engine to the internal data metrics, the external data metrics, and the plurality of rules;
selecting a particular classification engine from the plurality of classification engines based on the comparison; and
providing the particular classification engine for document classification.

13. The method of claim 12, wherein, during the comparison and prior to selecting the particular classification engine, the method comprises:
identifying, from the plurality of classification engines, a subset of classification engines configured to support the plurality of rules, wherein the subset of classification engines includes the particular classification engine; and
determining whether the subset of classification engines includes more than one classification engine.

14. The method of claim 13, further comprising, responsive to determining that the subset of classification engines includes only one classification engine, selecting the one classification engine as the particular classification engine.

15. The method of claim 13, wherein, in response to a determination that there is more than one classification engine in the subset of classification engines, during the comparison and prior to selecting the particular classification engine, the method comprises:
ranking each classification engine in the subset of classification engines based on an ability to support the internal data metrics and an ability to support the external data metrics; and
identifying a given classification engine having a top rank such that the particular classification engine corresponds to the given classification engine.

16. The method of claim 13, wherein, in response to a determination that there is more than one classification engine in the subset of classification engines, during the comparison and prior to selecting the particular classification engine, the method comprises:
identifying a classification engine in the subset of classification engines configured to support: (i) at least a threshold number of the internal data metrics and (ii) at least a threshold number of the external data metrics, wherein the particular classification engine corresponds to the identified classification engine.

17. A non-transitory computer-readable storage medium comprising instructions that, when executed by one or more processors, cause the one or more processors to perform functions comprising:
receiving metadata from each classification engine of a plurality of classification engines, the metadata indicating operational characteristics for a corresponding classification engine, and wherein the plurality of classification engines run on the one or more processors;
determining internal data metrics by polling internal resources corresponding to the one or more processors;
determining external data metrics by polling external resources that are isolated from the one or more processors;
accessing a plurality of rules for application to each document during document classification;
comparing the metadata from each classification engine to the internal data metrics, the external data metrics, and the plurality of rules;
selecting a particular classification engine from the plurality of classification engines based on the comparison; and
providing the particular classification engine for document classification.

18. The non-transitory computer-readable storage medium of claim 17, wherein, during the comparison and prior to selecting the particular classification engine, the functions comprise:
identifying, from the plurality of classification engines, a subset of classification engines configured to support the plurality of rules, wherein the subset of classification engines includes the particular classification engine; and
determining whether the subset of classification engines includes more than one classification engine.

19. The non-transitory computer-readable storage medium of claim 18, wherein the functions comprise, responsive to determining that the subset of classification engines includes only one classification engine, selecting the one classification engine as the particular classification engine.

20. The non-transitory computer-readable storage medium of claim 18, wherein, in response to a determination that there is more than one classification engine in the subset of classification engines, during the comparison and prior to selecting the particular classification engine, the functions comprise:
ranking each classification engine in the subset of classification engines based on an ability to support the internal data metrics and an ability to support the external data metrics; and
identifying a given classification engine having a top rank such that the particular classification engine corresponds to the given classification engine.
